(19) United States
(12) Patent Application Publication
(10) Pub. No.: US 2005/0145324 A1
(43) Pub. Date: Jul. 7, 2005

(54) Bendable thin wood process

(76) Inventor: Cheng Hsiung Huang, Shu Lin City (TW)

Correspondence Address: Cheng Hsiung Huang, PO Box 82-144, Taipei, TW

(21) Appl. No.: 10/735,879

(22) Filed: Dec. 16, 2003

(51) Int. Cl. B27H 1/00

(52) U.S. Cl. 156/196; 144/381

(57) ABSTRACT

A process for bendable thin wood by having the thin wood impregnated in high pressure and vacuum conditions; both surfaces on top and bottom of the thin wood then coated with glue, bound with a sheet of color paper, overlapped with another sheet of white paper with all the sheets of paper pre-impregnated in melamine; the thin wood being dried in an oven to reduce the fibers of the paper and get hardened again before bending processed at high pressure and high temperature for the high pressure laminate bounded with sheets of color paper and white paper giving elongation property to become fire withstanding, water proof, and chemical resistant while providing multiple color options, scratch proof appearance, color fast and paint free results.

### BACKGROUND OF THE INVENTION

(a) Technical Field of the Invention

The present invention is related to a process for bendable wood, and more particularly, to one having a thin wood first coated with glue on both surfaces on top and bottom layers, and then bound in sequence with a sheet of color paper and another sheet of white paper before being synchronously treated at high pressure and high temperature for the thin wood to become bendable; and further treated by having the color paper and the white paper impregnated in melamine to permit bending work as a plank does while the surface of the thin wood is given an appearance of variable color graining and scratch proof performance.

(b) Description of the Prior Art

Whereas, in the trades of furniture, interior decoration and carpenter today, thin wood is essentially used for decorative purpose. In the prior art of bending process as illustrated in FIG. 1, a sheet of thin wood (10) is pretreated. To add strength and attractive appearance of the surface of the thin wood (10), a sheet of craft paper (20) is bound to the surface of the thin wood (10). The thin wood (10) adhered with the craft paper (20) is impregnated in melamine solution and dried for the craft paper to get hardened, and then laminated at high pressure and high temperature (approximately in the range of 130˜150° C.) and bent to come up with the finished product, also known as the high pressure laminate, generally available in the market.

As illustrated in FIGS. 2 and 3, though the high pressure laminated processed from the thin wood (10) adhered with the craft paper (10) is given with fire withstanding, water-proof and chemical resistant properties for popularly applied in the decoration purpose as a face panel or on a piece of furnish; it permits bending only in its longitudinal direction since those fibers in the craft paper (10) indicates one-way distribution making the high pressure laminate applicable for simply curvature works. When it comes that lateral bending is required, the high-pressure laminate fails. If the curvature, arc or continuous curvatures less than 90° are required, cripples appear, or cracks in serious case causing the bottleneck to the lateral curvature for the high-pressure laminate and problems of having the desire curvature for a certain angle are pending further improvement and solutions.

### SUMMARY OF THE INVENTION

The primary purpose of the present invention is to provide a process for a bendable thin wood in the form of a high-pressure laminate for the finished surfaces to achieve the purposes of fire withstanding, waterproof and chemical resistant while providing multiple color options, scratch proof appearance, color fast and paint free results.

To achieve the purpose, both top and bottom of the thin wood are applied with glue. The thin wood is bound with a sheet of color paper (wood graining preferred) overlapped with another sheet of white paper on both of the top and the bottom. All sheets of color paper and white paper have been impregnated in melamine solution before being bound to the thin wood. The thin wood is then dried in an oven for fibers of the paper to reduce and get hardened once again. The dried thin wood is then bent into shape as desired at high pressure and high temperature. The thin wood and the pretreated sheets of paper adhered to the thin wood are synchronously bent under the working conditions of high pressure and high temperature into a finished product of curved high-pressure laminate. Densely constructed fibers in both warp and weft directions are given at the same time tensile strength and elongation to permit perfect adhesion of the sheets of paper along the curvature of the thin wood, and the pretreated sheets of paper reinforce the both sides of the finished thin wood.

The foregoing object and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a process flow chart of the prior art.

FIG. 2 is an exploded view of the prior art.

FIG. 3 is a schematic view showing an assembly of the prior art.

FIG. 4 is a process flow chart of the present invention.

FIG. 5 is an exploded view of the present invention.

FIG. 6 is a schematic view showing an assembly of the present invention.

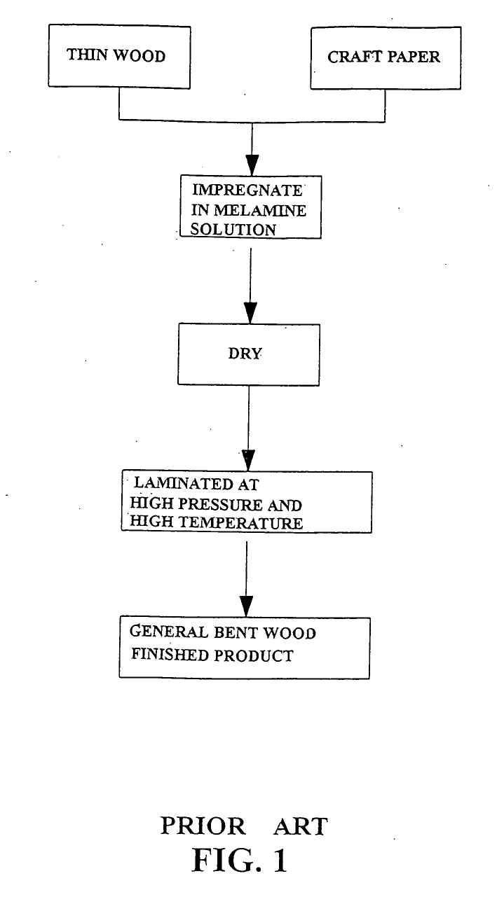

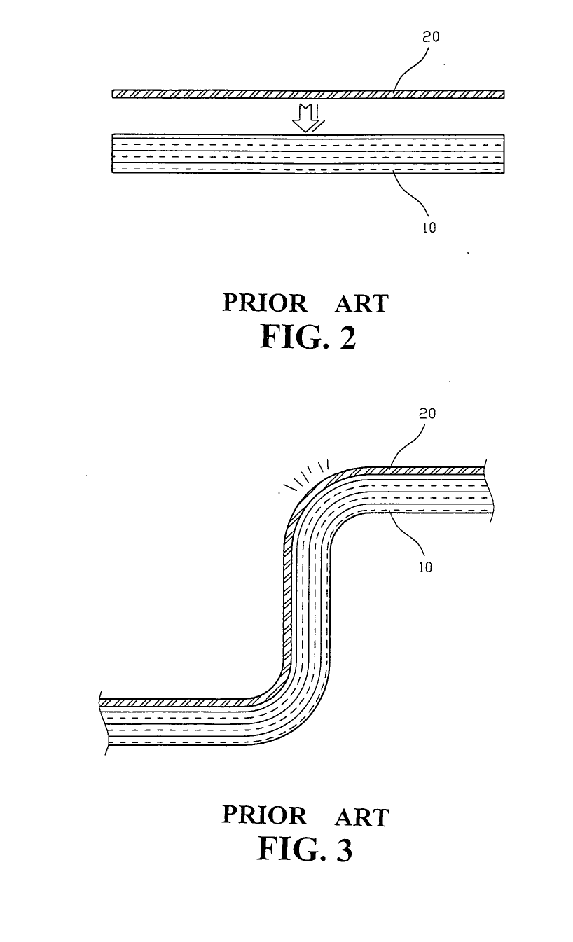

### DETAILED DESCRIPTION OF THE PREFERRED EMBODIMENTS

The following descriptions are of exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

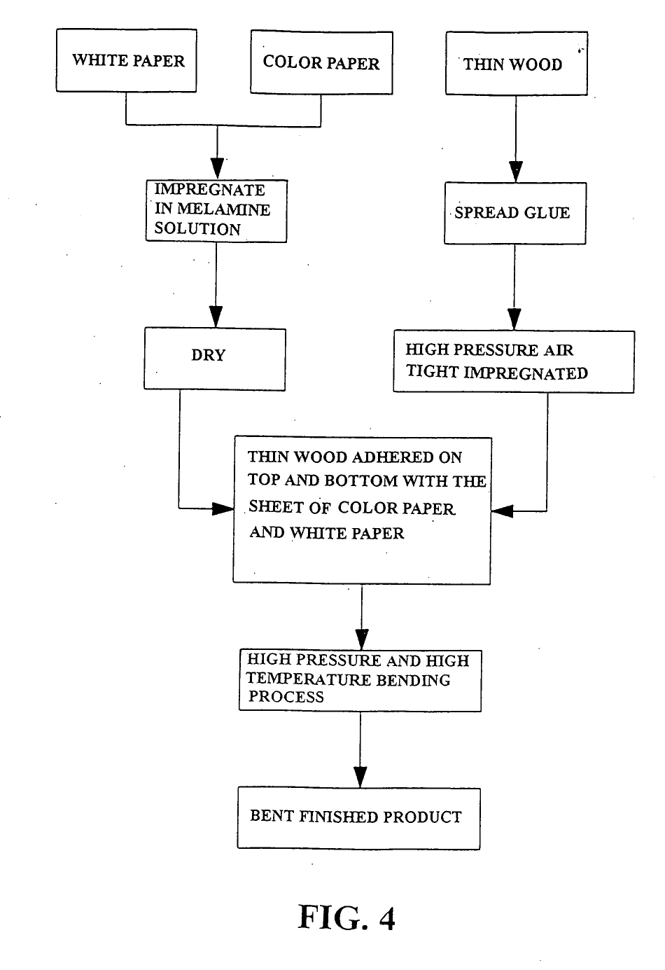

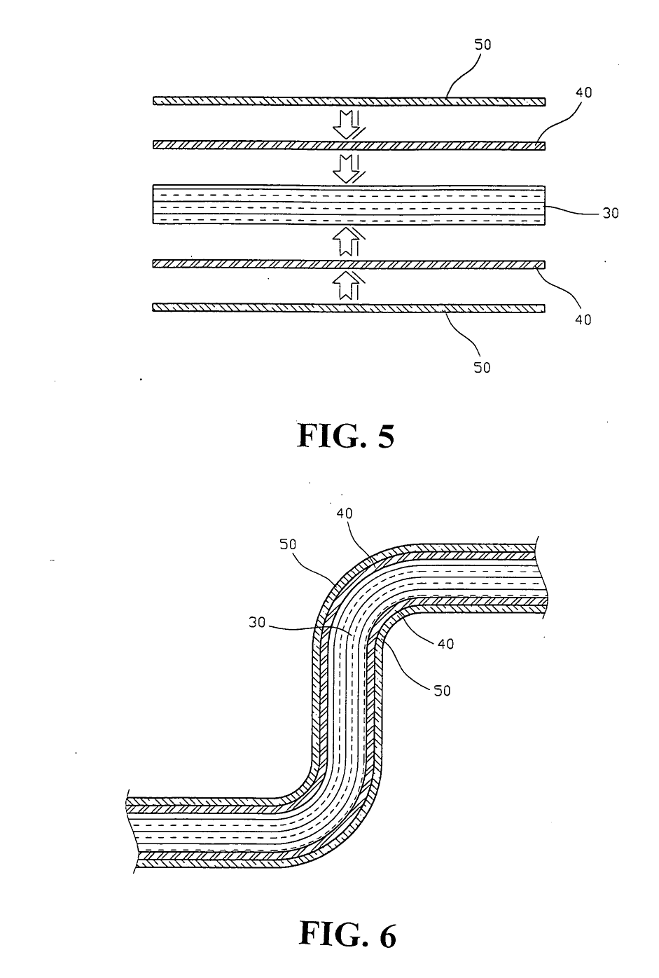

Referring to FIG. 4 for a process flow chart of the present invention, FIG. 5 and FIG. 6, the present invention relates to a process for a bendable thin wood. A thin word [30] is impregnated in melamine solution. Sheets of color paper [40] and white paper [50] are also pretreated with the impregnation in melamine solution. Both of the top and bottom of the thin wood [30] are applied with glue. Both of the color paper [40] and the white paper [50] are dried in an over to reduce fibers for them to get hardened again. One sheet of the color paper [40] is then each adhered to the top and the bottom of the thin wood [30] overlapped with another sheet of the white paper [50]. The thin wood [30] adhered on it top and bottom with the sheet of the color paper [50] and the sheet of the white paper is undergoing the bending process at high pressure and high temperature to become a finished product bent in the shape as desired. Fibers of the paper are impregnated first in the melamine solution and then dried in the oven for reduction to get hardened again for the thin wood to become a high-pressure laminate allowing bending at angles that failed by the conventional high-pressure laminate due to that fibers of the paper densely constructed in both ways of waft and weft give the tensile strength and elongation for the paper to flush bind to the surface of the thin wood. The color paper gives various color tones and graining patterns for the finished product of the thin wood to have attractive appearance. Furthermore the impregnated paper also gives additional strength and higher colorfastness to the surface of the thin wood for the thin wood to provide fire withstanding, waterproof and chemical resistant properties while achieving the results of scratch free and paint free.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

1. A process for bendable thin wood, wherein, the thin wood being impregnated in high pressure and vacuum conditions; both surfaces on top and bottom of the thin wood then coated with glue, bound with a sheet of color paper, overlapped with another sheet of white paper with all the sheets of paper and the thin wood pre-impregnated in melamine; the thin wood being dried in an oven to reduce the fibers of the paper and get hardened again; hardened fibers giving tensile strength and elongation; and the thin wood being bent into the shape desired; is characterized by that the paper being bent together with the thin wood, perfectly flush bound on the curvature, and the melamine impregnated paper effectively improving the strength of the surface of the thin wood to become fire withstanding, water proof, and chemical resistant while providing multiple color options, scratch proof appearance, color fast and paint free results.
